(19) United States
(12) Patent Application Publication
(10) Pub. No.: US 2025/0378557 A1
(43) Pub. Date: Dec. 11, 2025

(54) GEOMETRY MEASUREMENT AND QUANTITATIVE INTEGRITY ANALYSIS OF DONOR TISSUE

(71) Applicant: Clemson University, Clemson, SC (US)

(72) Inventors: Shangping Wang, Mount Pleasant, SC (US); Shuchun Sun, Charleston, SC (US); Hai Yao, Mount Pleasant, SC (US); Jichao Zhao, Charleston, SC (US); Ge Pan, Charleston, SC (US)

(73) Assignee: Clemson University Research Foundation, Clemson, SC (US)

(21) Appl. No.: 19/229,909

(22) Filed: Jun. 5, 2025

Related U.S. Application Data
(60) Provisional application No. 63/657,145, filed on Jun. 7, 2024.

(51) Int. Cl. G06T 7/00; G06T 7/62

(52) U.S. Cl. CPC G06T 7/0012; G06T 7/62; G06T 2207/10008; G06T 2207/30024

(57) ABSTRACT

This system is a measurement and analysis system of donor tissue comprising: a three-dimensional (3D) scanner in communication with a computer having computer readable instructions; a donor tissue disposed in a sterile container; where the 3D scanner is adapted to scan a donor tissue to provide a dataset representing a 3D digital representation of the donor tissue that can be displayed on the computer; and, wherein the computer readable instructions are adapted to receive the dataset from the 3D scanner; determine dimensions of the donor tissue from the dataset and detect if a defect exists in the donor tissue. The system can include 3D scanner and a computer cooperatively associated and adapted to scan a donor tissue, provide a 3D digital representation of the donor tissue that can be visually displayed; determine dimensions of the donor tissue and detect if a defect exists in the donor tissue.

### CROSS-REFERENCE TO RELATED APPLICATIONS

This application claims priority to United States Provisional Patent Application 63/657,145 filed Jun. 7, 2025, which is hereby incorporated by reference in its entirety.

### GOVERNMENT LICENSE RIGHTS

This invention was made with government support under P20GM121342 and R01DE021134 awarded by the United States National Institutes of Health. The United States government has certain rights in the invention.

### BACKGROUND

### 1) Field of the Invention

This system is directed to an easy-to-implement method using a 3D scanner to achieve rapid and precise capture of the 3D geometry of donor meniscus while maintaining sterility, asepsis, and preservation conditions. The system uses analysis algorithms to provide a user-friendly interface for assessing tissue surface integrity.

### 2) Description of the Related Art

Meniscus lesions are the most frequent type of knee injuries among young, active patients, which can alter the transmission of loads across the knee joint and lead to knee instability. In the United States, approximately one million patients with meniscus injuries undergo surgical treatments each year, of which 80% of meniscal injuries are irreparable and require partial or total meniscectomy. However, pain, transient effusion, and knee osteoarthritis (OA) are common findings after partial and total meniscus resection. Currently, meniscal allograft transplantation (MAT) with human cadaver tissues, is considered medically necessary for treatments with symptomatic post meniscectomy knees with major meniscus loss. While MAT enables favorable outcome in the long term, the challenge of donor-recipient size matching strongly limits the broad implementation of MAT.

To address this issue, tissue banks employ various methods to preserve and store meniscal allografts, including ambient storage, cold storage, fresh-freezing, and cryopreservation. These methods provide more options for achieving effective size-matching between donors and recipients. However, the current size measurement methods used in tissue banks are limited to two-dimensional (2D) measurements, relying on direct anatomic landmarks and photographic measurements. These 2D techniques often suffer from inaccuracies due to challenges such as lens positioning and the irregular 3D shape of the meniscus. Although radiographic measurement methods, utilizing computed tomography (CT) or magnetic resonance imaging (MRI), can provide superior accuracy and 3D information, their implementation during allograft procurement in tissue banks is hindered by their time-consuming and costly nature. Therefore, these solutions are resource prohibitive and are impractical to implement.

Efficient procurement, accurate size measurements, quality screening, and proper storage are crucial elements of effective tissue banking processes. Transplantation of a banked allograft, such as meniscus, is among the treatment options for young patients with knee pain after meniscectomy. The success of transplantation is influenced not only by surgical technique but also by the precise matching of the donor meniscus allograft size with that of the recipient. Ensuring this precise size matching hinges on the accuracy of the geometry measurements of the donor meniscal allografts. Current techniques employed in tissue banks, such as direct anatomical and photographic methods, are limited to two dimensional (2D) measurements. These techniques often falter in accuracy due to challenges like lens positioning and the irregular 3D shape of the meniscus.

Although radiographic measurement methods utilizing computed tomography (CT) or magnetic resonance imaging (MRI) can provide improved accuracy and 3D information, their implementation during allograft procurement can be challenging. Additionally, these methods lack robust quantitative assessments of tissue integrity. Donor menisci can exhibit various defect modes, including meniscus wear that may lead to degenerative meniscus tears over time, vertical longitudinal tears, horizontal tears, and radial transverse tears, especially some of which are difficult to distinguish through visual observation alone. Unidentified defects and incorrect categorization during storage in tissue banks can compromise transplant success.

Another limitation in the field is the unsophisticated assessment of the structural integrity of the meniscus primarily as it is heavily dependent on visual observations conducted by operators. This reliance on visual inspection can pose significant challenges when it comes to detecting and categorizing defects in donor menisci, especially those with dimensions measured in millimeters. Defective donor tissue can significantly undermine the success and recovery of the patient.

Further, a significant challenge with current technology in ensuring the success of meniscal allograft transplantation since success can be dependent on achieving precise size-matching. Current 2D measurement methods primarily capture approximate length, width, and height measurements, which fall short in accurately representing the irregular geometric parameters of the meniscus, such as the curvatures of its superior surface.

It would be advantageous and an improvement in the current state of the technology if there were a system that can accurately detect defects in donor tissue since such defects have significant disadvantages. These defects may include wear, vertical longitudinal tears, horizontal tears, and radial transverse tears. Failure to identify such defects accurately during storage in tissue banks has the potential to compromise the success of subsequent transplants and cause serious complications with the patient.

It would be advantageous to have a system that can meet the pressing demand for the efficient size-matching and defect detection of meniscal transplants to improve the chances of and even ensure successful transplantation.

It would be advantageous to have a system that streamlines the tissue banking processes and includes an easy-to-implement method using a 3D scanner to achieve rapid (e.g., sub minute scan times) and accurate capture of the 3D geometry of donor meniscus while maintaining sterility, asepsis conditions, and preservation requirements.

It would also be advantageous to have a system that included a user-friendly interface for assessing tissue surface integrity through the development of cutting-edge analysis algorithms.

It would be advantageous to have a system that uses a straightforward 3D scanning workflow for capturing the geometry of meniscal allografts while maintaining sterile-aseptic conditions in a preservation solution.

### SUMMARY

The above objectives are accomplished by providing A system for measurement and analysis of donor tissue comprising: a three-dimensional (3D) scanner in communication with a computer having computer readable instructions; a donor tissue disposed in a sterile container; where the 3D scanner is adapted to scan a first side of the donor tissue and a second side of the donor tissue to provide a dataset representing a 3D digital representation of the donor tissue that can be displayed on the computer; and, wherein the computer readable instructions are adapted to receive the dataset from the 3D scanner; determine dimensions of the donor tissue from the dataset and detect if a defect exists in the donor tissue. The donor tissue is disposed in a transparent container that can be flexible. The donor tissue can be knee meniscus or a meniscus of a temporomandibular joint (TMJ).

The computer readable instructions are adapted to determine flatness, maximum curvature, minimum curvature, and a shape index from the dataset and can use one of more of flatness, maximum curvature, minimum curvature, mean curvature, Gaussian curvature, Laplacian curvature, and a shape index. The computer can be adapted to transmit a set of dimensions and a donor identification to a central server. The computer readable instructions are adapted to display a warning when a detect is detected. The defect type od the donor tissue can be taken from the group of wear, vertical longitudinal tears, horizontal tears, radial transverse tears and any combination thereof.

A system for measurement and analysis of donor tissue comprising a 3D scanner in communication with a computer where in the 3D scanner and the computer are cooperatively associated and adapted to scan a donor tissue, provide a 3D digital representation of the donor tissue that can be visually displayed; determine dimensions of the donor tissue and detect if a defect exists in the donor tissue. The donor tissue can be disposed in a solution which can be phosphate-buffered saline.

A system can include comprising: a 3D scanner in communication with a computer; wherein the 3D scanner is adapted to scan a donor tissue and provide a dataset to the computer; and, wherein the computer is adapted to receive the dataset and according to the dataset, provide a 3D digital representation of the donor tissue, determine dimensions of the donor tissue, detect if a defect exists in the donor tissue and any combination thereof.

### BRIEF DESCRIPTION OF FIGURES

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1A is perspective view of harvesting a donor tissue;

FIG. 1B is a front view of storing a donor or test tissue;

FIG. 2 is a schematic of aspects of the system;

FIG. 3 a top view of defects in a donor or test tissue;

FIG. 4 is a top view of a donor or test tissue and a three-dimensional representation thereof;

FIG. 5 is a top view of a donor or test tissue and a three-dimensional representation thereof;

FIG. 6 is a donor or test tissue, digital representation and one embodiment of defect detection results;

FIG. 7 is an exemplary graphical user interface.

FIG. 8 is a schematic of the system.

### DETAILED DESCRIPTION

The system described herein has the ability to improve the current state of the technology by providing a practical solution for tissue banks as well as addressing the following aspects: a) establishing a database for precise tissue geometry; b) identifying the presence of defects; c) pinpointing the locations of these defects; d) providing recommendations for proper categorization; and e) improving the success rate of associated medical procedures by providing a tissue bank that allow rapid acquisition and dataset generation of tissue 3D geometry will form the foundation for effective donor-recipient size matching. These improvements are seen by combining geometry data extracted from recipient knee joints through MRI or CT scans and matching these with donor tissue criteria previously captured and placed on the donor bank database. The system improves the technology by providing not before seem defect detection and evaluation capabilities that can streamline allocation of donated grafts and optimize their utilization in clinical applications and research.

It should be noted that this system can be used for various tissue types and can revolutionize the donor tissue procurement and allocation processes within tissue banks.

This system addresses one of the most significant challenges in ensuring the success of meniscal allograft transplantation. That is this system can provide for greatly improved precise size-matching between the patient and the donor tissue. Unlike the present system, current 2D measurement methods primarily capture approximate length, width, and height measurements, which fall short in accurately representing the irregular geometric parameters of the meniscus, such as the curvatures of its superior surface. To address this, the system uses 3D optical scanning to acquire meniscus geometry of the donor tissue while the donor tissue remains in a sterile environment. This innovative approach overcomes prior limitations by providing comprehensive 3D geometric data, essential for achieving precise size and shape matching. Moreover, the current system as superior advantages when compared to medical imaging techniques like CT and MRI, as the present system is it not only time-efficiency but also is cost-effective.

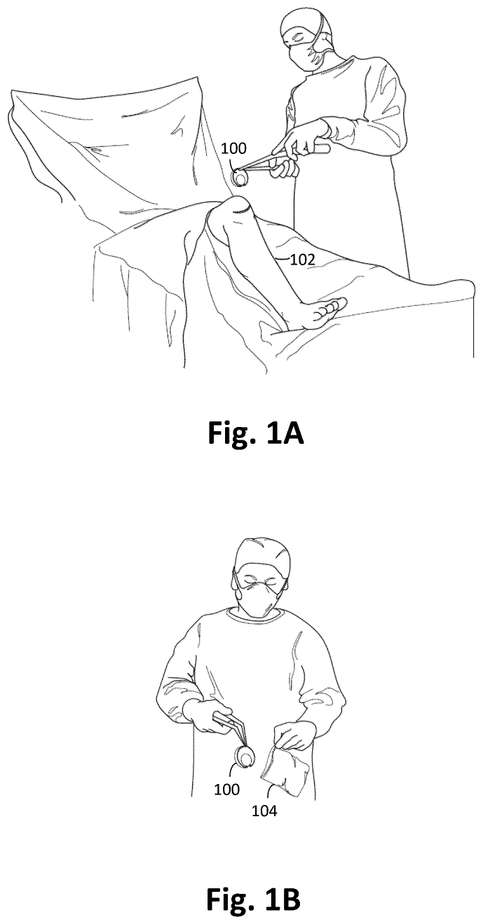

With reference to the drawings, the invention will now be described in more detail. Referring to FIGS. 1A and 1B, a donor tissue 100 is removed from a cadaver 102 is shown placed in a container 104, which can be sealed. The container can be a flexible transparent container such as a plastic bag. The donor tissue can be placed in the container in a sterile environment allowing the donor tissue to be removed from the sterile environment while preventing contamination of the donor tissue.

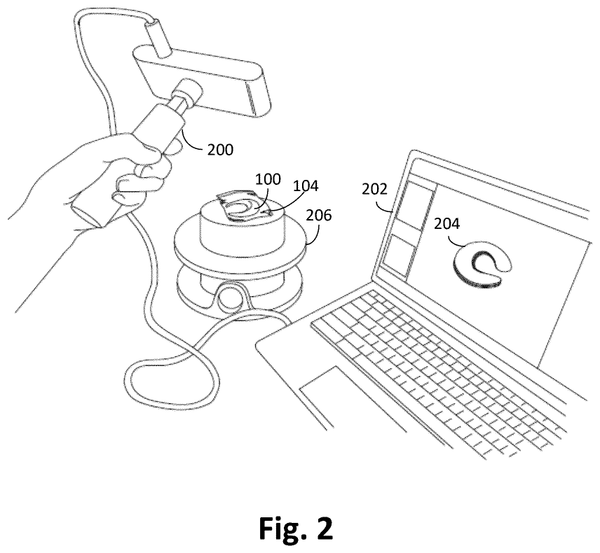

Referring to FIG. 2, a three (3D) dimensional scanner 200 can be used to scan the donner tissue 100 that can remain in the sterile container 104. The donor tissue can be scanned from all sides allowing for a 3D scan of the donor tissue. The scan can be transmitted to a computer device 202 and a digital representation 204 (e.g., 3D scans) of the donor tissues can be stored and displayed. The 3D digital representation of the donor tissue with dimensions of the donor tissue that can be placed on the donor tissue database.

Therefore, this system provides for a straightforward and practical 3D scanning approach that can accurately scan tissues, even when they are enclosed in containers such as transparent storage bags and can maintain a sterile environment. The donor tissue can be stored in a clear solution within the container as well. This system maintains sterility and aseptic conditions necessary for the preservation of meniscal allografts, an important consideration in medical procedures. The system also includes implementation of curvature-based algorithms to identify various types of surface tears and wear in the meniscus. These algorithms are accurate for defect detection and highly compatible with 3D optical scanned geometries. A user-friendly graphical user interface is included that streamlines the operational process and facilitates clear, intuitive visualization of the analysis results. By integrating computer readable instructions with this accessible software, tissue banks will gain the capability to establish refined classification, search, and storage policies.

The system can provide for improved size-matching efficiency by using a 3D scanning workflow to capture the geometry of entire meniscus and leveraging various curvature analysis algorithms to comprehensively evaluate tissue integrity on the 3D scanned meniscus surface, including the detection of defects that are otherwise undetectable.

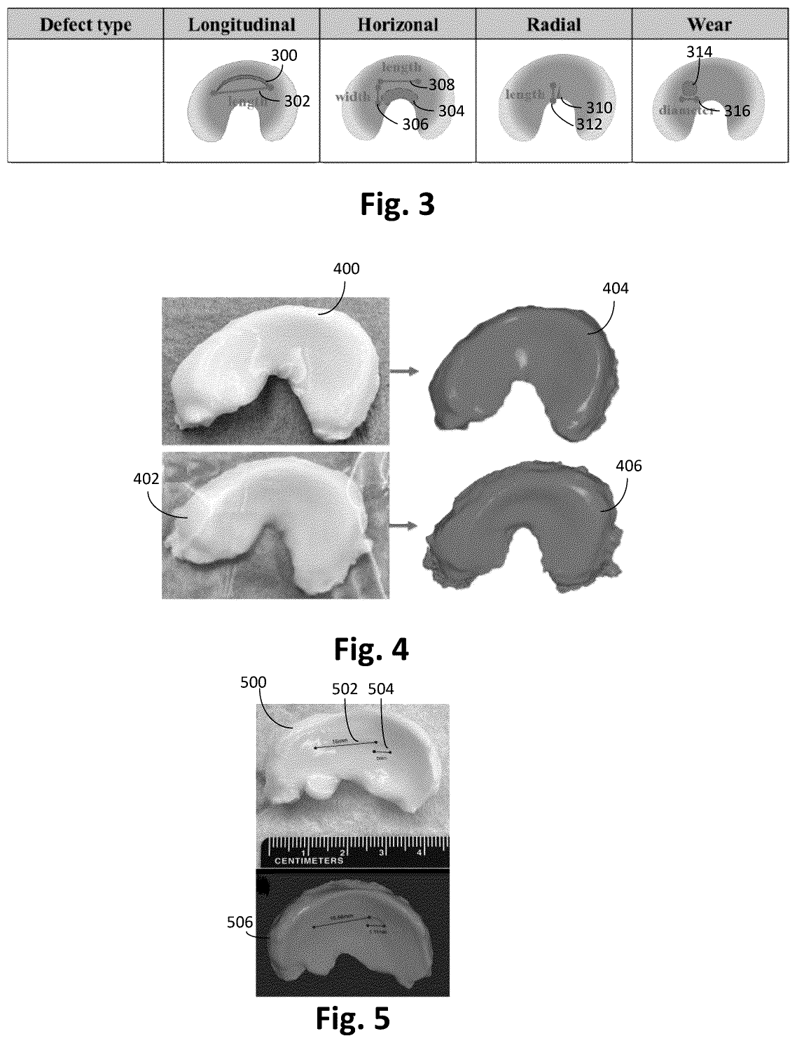

In operations, the scanning provided results shown in FIG. 3 using a power analysis based on an alpha of 0.05, a desired power of at least 80% and an expected difference between means and standard deviations based on captured data and studies on meniscal, articular cartilage and cartilage endplate tissues. The system will be able to determine various types of defects with different sizes and configuration. For example, the system can detect a longitudinal defect 300 having a length of 302. This defect can be determined from the 3D scan and may not be detectable with the naked eye. Currently, defects are challenging to detect. The 3D scan can detect a horizontal defect 304 having a width 306 and height 308. The 3D scanner can also detect radial tears 310 having a length 312. The 3D scanner can also detect wearing 314 on the donor tissue having a diameter of 316.

Meniscal allograft transplantation (MAT) has emerged as a standard treatment for patients suffering from symptomatic post-meniscectomy knees. Although MAT enables favorable outcome in the long term, the primary challenge lies in achieving precise donor-recipient size matching, a limitation that hinders its widespread implementation of MAT. Current 2D measurement methods employed in tissue banks focus primarily on approximate length, width, and height measurements. Unfortunately, these methods inadequately capture the irregular geometric parameters of the meniscus, such as the curvatures of its superior surface. Additionally, due to the sensitivity of fibro chondrocyte cells within donor meniscus to physiological changes post-cadaveric procurement, it is essential to immediately immerse the donor menisci in a preservation solution to maintain their overall properties. Therefore, this system allows for the conducting of geometry measurements under sterile and preserved conditions allowing for more effective tissue preservation. Furthermore, aside from acquiring accurate overall 3D dimensions and shapes, this system captures surface integrity information on the donor tissue. Considering the meniscus's limited self-repair ability, even minor defects like wear or tears on the donor tissues can compromise their functionality, consequently resulting in a significant impact on clinic outcomes post transplantation. In this aim, this system can identify the minimum size required for each type of defect to be detectable through scanning, providing a baseline that could be used for further defect detection procedures.

A 3D scanner (e.g., Revopoint POP 3) can be used having a high precision of 0.05 mm and a scanning rate of 18FPS to rapidly capture the 3D geometry of the meniscus within about 1 minute. During the scanning process, the sample can be securely positioned on rotating table 206 as illustrated in FIG. 2. The system successfully obtained 3D scanned geometries of the meniscus in two conditions: one 400 without any additional elements and another 402 within a colorless phosphate-buffered saline (PBS) solution contained in a transparent storage bag within about a 1-minute scanning period. The resulting scans are 404 and 406 respectively. The geometry of the sample within the solution and bag closely resembled that of the sample without the bag, showing that the interference resulting from differences in the refractive indices of the PBS solution and the bag did not negatively impact the scanning reconstruction.

Referring to FIG. 5 illustrating the results and components of one test of the system, two defects were introduced into the test sample 500: one with a longitudinal tear 502 measuring 16 mm in length and 1 mm in depth and another with a wear 504 having a diameter of 5 mm and a depth of 1 mm. A comparison of the measured defect sizes in the test sample and its corresponding 3D geometrical representations 506 captured within the solution and bag, the relative difference between the measurements conducted on the 3D geometry and those on the test sample fell within a small range of 2.8±1.5% for the length of the longitudinal tear (n=5) and 4.1±1.5% for the diameter of the wear (n=5), respectively. Therefore, this system shows that regardless of the presence of the PBS solution and bag the accurate capture of the 3D dimensions and shapes of meniscus can be performed. The measurements closely aligned with those obtained from the actual tissue samples, confirming their precision and reliability of this system.

This system shows that the 3D geometry of the meniscus can be effectively captured within the PBS solution and bag without any significant compromise, as per the systems scanning protocol. The advantages of the system can be further shown since it has the ability to detect the three of the most prevalent types of meniscal tears (i.e. longitudinal, horizontal, and radial tears) and one form of wear. The defects that can be detected include first longitudinal (vertical) tears, which run perpendicular to the tibial plateau and parallel to the long axis of the meniscus, are typically located in the vascular red outer zone of the meniscus. They can disrupt the superficial radial collagen fibers in alignment with the circumferential fibers, potentially affecting the mechanical function of meniscus and leading to more severe tears post-transplantation. Second, horizontal tears that divide the meniscus into two layers are considered to rarely heal, even when minor, due to their occurrence in the avascular white zone. Third radial (vertical) tears, which disrupt the circumferential collagen fibers and impact the ability of the meniscus to absorb tibiofemoral load, are also typically found in avascular white areas and have limited self-repair capability.

Also, there is meniscal wear which refers to the gradual thinning and deterioration of the meniscus, influenced by factors like aging, acute injury, and increased knee joint pressure.

In practice fresh menisci (e.g., donor tissue) are harvested under sterile conditions (e.g., biosafety cabinet) to maintain the sterile and aseptic environment and immediately placed in a storage bag filled with the PBS solutions.

Testing of the system has successfully demonstrations of clear scanning of wear with a diameter of 5 mm and a depth of 1 mm. In one embodiment, all defect sizes exceeding these dimensions will be easily scannable and identifiable in the 3D scanned geometry. In cases where defects of smaller sizes cannot be scanned by our 3D scanning technology, the system can gradually increase the dimensions until a minimum scannable threshold is reached. Conversely, if defects of smaller sizes are scanned, the system can systematically reduce the dimensions until a minimal limit is reached.

Currently, an effective approach for analyzing meniscus tissue integrity is notably absent in tissue bank operations. Direct observation of meniscus surface tear and wear is significantly challenged by its semi-transparent nature, making direct measurement of the severity of wear and tear nearly impossible. Therefore, this system uses 3D scanning and effective mathematical computer readable instructions to identify the wear and tear and evaluate the severity. The system uses analysis algorithms tailored for comprehensive evaluation of tissue integrity on 3D scanned meniscus surfaces.

The system uses computer readable instruction that include curvature-based algorithms, encompassing techniques such as maximum curvature, minimum curvature, and Gaussian curvature, due to their efficiency in detecting variations (including subtle variations) in surface topology which is an indicator of wear and tear on the donor tissue. The computer readable instructions are particularly advantageous for accurately detecting defects that are otherwise not easily visible and addressing the inherent limitations posed by the meniscus's wear and tear properties. Understanding that different defect type patterns could be accomplished using distinct algorithms for optimal detection with established thresholds for each algorithm.

Additionally, this system includes an intuitive graphical user interface (GUI). This GUI is designed to make these sophisticated analyses accessible and practical for a broad range of users, particularly in tissue bank settings, ensuring that the detailed data generated is both interpretable and actionable. The careful tailoring of the system to these challenges is key in ensuring the accuracy and reliability of our assessments, ultimately contributing to more informed decision-making in meniscus storage and transplantation.

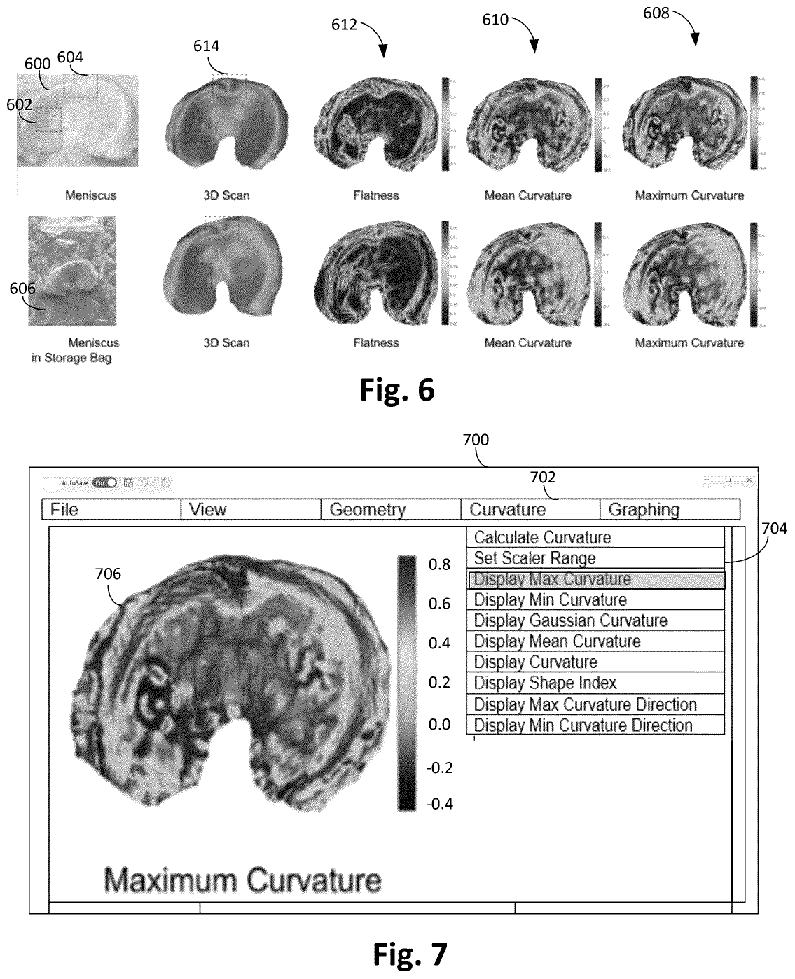

In testing, results demonstrate the effectiveness of the curvature-based algorithms detecting meniscus wear and tear. Data processing algorithms were developed in MATLAB and validated using known geometry such as cylinder, box, and ball. Referring to FIG. 6, this system successfully identified both wear 602 and tear 604 patterns, even when the meniscus 600 was submerged in transparent preservation solutions 606. Specifically, wear patterns, characterized by a 5 mm diameter and 1 mm depth in the basin, were accurately detected using maximum curvature 608, mean curvature 610, and flatness analysis 612 embodied in computer readable instructions. Tear patterns 614, with a 5 mm width and 1 mm depth at the ridge, were clearly identified by mean curvature and maximum curvature analysis.

The small size of this wear and tear pattern underscores the exceptional sensitivity of the system. This ability to detect defects under varied conditions, including the presence of preservation solutions and storage bags, albeit with a slight reduction in resolution, suggests the robustness of our approach. Furthermore, a basic GUI which allows interaction with the computer readable instructions incorporates these algorithms, enhancing the ease of data interpretation and usability as shown in FIG. 7. This GUI streamlines the analysis process, making sophisticated detection methods more accessible and user-friendly for application in tissue banks and clinical settings. This system can include a GUI 700 that has a top menu bar 702 and drop-down section 704. When selected, the indicated image 706 can be displayed. In one embodiment, the curvature is indicated with pseudo color with each color indicating a height from a zero plane.

The system provide for the processing of defect patterns and can calculate key curvature indicators on the surface of donor tissues. These indicators include flatness, maximum curvature, minimum curvature, mean curvature, Gaussian curvature, and the shape index. These indicators provide a detailed understanding of the surface integrity of donor tissues, such as the meniscus and TMJ.

Concerning maximum curvature and minimum curvature, at a given point on the surface, these are the maximum and minimum values of curvature in different directions. The maximum curvature Kwin indicates the curvature in the most convex direction on the surface, while the minimum curvature max indicates the curvature in the most concave direction. Concerning the mean curvature, this is the average of the maximum and minimum curvatures at a given point, describing the average bending of the surface. It can be represented as:

$$H = \frac{{k}_{min} + {k}_{max}}{2}$$

Concerning the gaussian curvature, this is the product of the maximum and minimum curvatures at a given point, representing the intrinsic curvature of the surface. It can be represented as:

$$K = {k}_{min} \cdot {k}_{max}$$

Concerning the shape index, this combines the ratios of the maximum and minimum curvatures to characterize the shape features of the surface. It is often used to categorize different types of surface geometries that can be found on donor tissue. These curvature indicators can comprehensively describe the morphological characteristics of the donor tissue surface, aiding in the detection and analysis of surface defects. This aspect of the system enhances the efficiency of donor tissue selection and reduces the potential for human error.

This system's clear detection results allow for the computer readable instructions to be effective in detecting various defect patten and sizes. In one embodiment, especially when wear and tear patterns prove challenging for curvature-based algorithms, the system can use gradients and Laplacians derived from these curvature measures. In one endowment, the following represents the application of Laplacian analysis in a cartesian coordinate system:

$$Δ f = \frac{{\partial }^{2} f}{\partial {x}^{2}} + \frac{{\partial }^{2} f}{\partial {y}^{2}} + \frac{{\partial }^{2} f}{\partial {z}^{2}}$$

which can use vector field nabal (∇) and produce a scalar value when applied to a vector field so that in cartesian coordinates the divergence of the vector field would be:

$$∇ \cdot F = 〈 \frac{\partial }{\partial x} , \frac{\partial }{\partial y} , \frac{\partial }{\partial z} 〉 \cdot 〈 f , g , h 〉 \frac{\partial f}{\partial x} + \frac{\partial g}{\partial x} + \frac{\partial h}{\partial x}$$

Gradients and Laplacian excel in detecting edges and contours with enhanced precision, making them capable of identifying subtler surface changes that may elude standard curvature-based algorithms. This system can uncover wear patterns that standard curvature calculations might overlook. In one embodiment, when the determination of algorithm detection thresholds proves complex or exhibit significant variations, manual adjustment capabilities within our graphical user interface and provided This feature will enable fine-tuning on a case-by-case basis, thereby enhancing the software's versatility and adaptability to specific scenarios.

In one embodiment, analysis computer readable instructions can leverage advanced tools such as Qt for user interface development, Visualization Toolkit—VTK for 3D visualization, and the Libel library for geometric computations. In one embodiment, these technologies were chosen to ensure not only the accuracy and efficiency of the system but also its user-friendliness. By integrating these sophisticated tools, this system makes significant advancements in the field of donor tissues (e.g., meniscus) storage and transplantation. This system, including its methodical approach and the GUI software greatly enhances the precision and reliability of donor tissues assessments in both tissue bank and clinical settings.

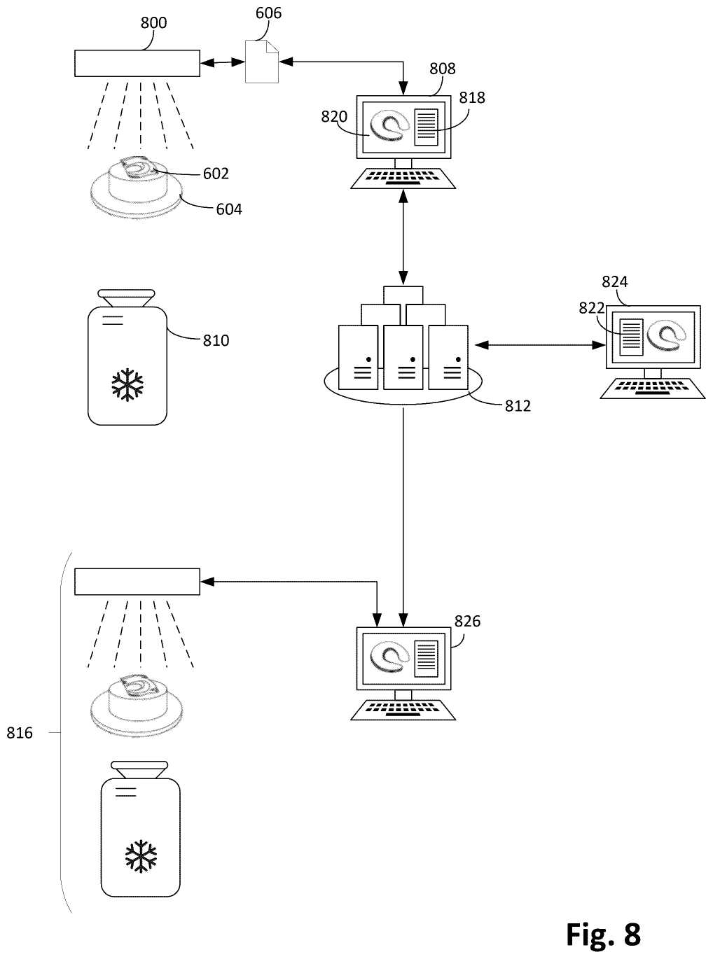

Referring to FIG. 8, the operation of the system is explained in further detail. A 3D scanner 800 ca be used to scan a donor tissue 602 which can be on a rotating table 604. The 3D scan creates a dataset 806 that can be transmitted to a computer 808. Upon completion of the scan, the donor tissue can be placed in storage 810. Computer 808 can create the 3D digital representation, determine the dimensions of the donor tissue, detect defects and other operations on the dataset. Donor tissue information 818 and image 820 can be transmitted to a central server 812 providing access to the donor tissue information from multiple sources such as remote computer system 826. The donor tissue information can include harvesting time, harvest source information (e.g. cadaver information such as age, sex, build, blood type, etc.), storage location, storage time and the like. The information can assist with assessing the viability of the donor tissue. For example, donor tissue that remain in storage for too long may no longer be viable. Other location can also scan donor tissue, upload datasets to computer and transmit the donor tissue information to the central server. The computer systems can display donor tissue information 818 a graphical information about the donor tissue 602. For example, the computer can display the 3D representation, pseudo-colored dimensions (peaks and valleys), pseudo-colored defects and surface features and the like as shown as 820.

When there is a need for a donor tissue, a user can enter search criteria 822 into a computer 824. The computer can transmit the search request and search information to the central server wherein the central server 812 can find a best match according to the search criteria. For example, the searching user may wish to discovery a meniscus that is a certain length, width, height, and curvature. The searching user enters this server finds the best match and provide the searching user with the results. The search results can include the donor tissue information as well as the location of the donor tissue allowing the search to be conducted nationwide and even worldwide. Searching is no longer limited to reaching out to each storage location individually.

It should be noted that donor tissue need not be only from a cadaver but can also originate from a live donor. Further this system can be used to analyze pre-existing stored donor tissue for use and viability.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A system for measurement and analysis of donor tissue, comprising:
a three-dimensional scanner configured to capture geometric data of a donor tissue;
a computer device in communication with the three-dimensional scanner;
wherein the three-dimensional scanner is configured to scan the donor tissue to generate a dataset representing a three-dimensional digital representation of the donor tissue; and
wherein the computer device is adapted to receive the dataset from the three-dimensional scanner, determine dimensions of the donor tissue from the dataset, and detect defects in the donor tissue using curvature-based analysis algorithms applied to the dataset and transmit the dimension defects to a remote server.

2. The system of claim 1, wherein the computer device is configured to transmitting the dimensions and a donor identification to a central server for storage in a donor tissue database.

3. The system of claim 2, wherein the entral server is configured to receiving search criteria from a remote computer system and providing matching donor tissue information from the donor tissue database according to the search criteria to the remote computer system.

4. The system of claim 1, wherein the donor tissue is disposed in a sterile container containing preservation solution.

5. The system of claim 1, wherein the curvature-based analysis algorithms include at least one of flatness analysis, maximum curvature analysis, minimum curvature analysis, mean curvature analysis, Gaussian curvature analysis, and shape index analysis.

6. The system of claim 5, wherein the computer device is adapted to calculate Laplacian curvature from the dataset to detect surface variations in the donor tissue.

7. The system of claim 1, wherein the defects detected include at least one of wear, vertical longitudinal tears, horizontal tears, and radial transverse tears.

8. The system of claim 1, further comprising a rotating table configured to support the donor tissue and rotate the donor tissue during scanning to enable capture of geometric data from multiple angles.

9. The system of claim 1, wherein the computer readable instructions are further configured to generate a digital display of the three-dimensional digital representation of the donor tissue with pseudo-color mapping indicating detected defects.

10. A computerized method for analyzing donor tissue integrity, comprising:
positioning a donor tissue within a sterile container;
scanning the donor tissue using a three-dimensional scanner to generate a dataset representing three-dimensional geometry of the donor tissue while the donor tissue remains within the sterile container;
transmitting the dataset to a computer device;
processing the dataset using computer readable instructions to determine dimensions of the donor tissue; and
detecting defects in the donor tissue by applying curvature-based analysis algorithms to the dataset, wherein the curvature-based analysis algorithms include at least one of maximum curvature analysis, minimum curvature analysis, mean curvature analysis, Gaussian curvature analysis, and flatness analysis.

11. The computerized method of claim 10, wherein the computer device is adapted to transmitting the dimensions and a donor identification to a central server for storage in a donor tissue database.

12. The computerized method of claim 11, wherein the donor tissue is placed in a sterile container containing a preservation solution.

13. The computerized method of claim 12 where the preservation solution is phosphate-buffered saline.

14. The computerized method of claim 10, further comprising a step of generating a digital image of the three-dimensional digital representation of the donor tissue with pseudo-color mapping indicating locations of detected defects.

15. The computerized method of claim 14, wherein the pseudo-color mapping indicates surface variations corresponding to at least one of flatness, maximum curvature, minimum curvature, mean curvature, and Gaussian curvature values.

16. A set of non-transient computer readable instructions that, when executed by a processor, cause the processor to perform operations comprising:
receiving a dataset from a three-dimensional scanner, the dataset representing three-dimensional geometry of a donor tissue scanned while disposed within a sterile container;
generating a three-dimensional digital representation of the donor tissue from the dataset;
determining geometric dimensions of the donor tissue from the dataset;
applying curvature-based analysis algorithms to the dataset to detect surface defects in the donor tissue; and
displaying a results of the defect detection, wherein the curvature-based analysis algorithms are configured to detect defects selected from the group consisting of longitudinal tears, horizontal tears, radial tears, and wear patterns.

17. The set of non-transient computer readable instructions of claim 16, wherein the curvature-based analysis algorithms include at least one of flatness analysis, maximum curvature analysis, minimum curvature analysis, mean curvature analysis, Gaussian curvature analysis, and shape index analysis.

18. The set of non-transient computer readable instructions of claim 17, including calculating Laplacian curvature from the dataset to detect subtle surface variations that are not detectable through standard curvature-based algorithms.

19. The set of non-transient computer readable instructions of claim 16, wherein the operations further comprise transmitting the geometric dimensions and a donor identification to a central server for storage in a donor tissue database.

20. The set of non-transient computer readable instructions of claim 19, including receiving search criteria from a remote computer system and providing matching donor tissue information from the donor tissue database according to the search criteria.
